(19) United States
(12) Patent Application Publication
(10) Pub. No.: US 2025/0104011 A1
(43) Pub. Date: Mar. 27, 2025

(54) SUPPLY CHAIN COMMAND CENTER FOR INTELLIGENT PROCUREMENT ASSISTANCE

(71) Applicant: ORACLE INTERNATIONAL CORPORATION, Redwood Shores, CA (US)

(72) Inventors: Vikas Agrawal, Hyderabad (IN); Jagdish Chand, Dublin, CA (US); Krishnan Ramanathan, Bengaluru (IN)

(21) Appl. No.: 18/680,364

(22) Filed: May 31, 2024

(30) Foreign Application Priority Data
Sep. 26, 2023 (IN) 202341064482
Sep. 26, 2023 (IN) 202341064658

(51) Int. Cl. G06Q 10/087; G06Q 10/0631; G06Q 10/067; G06Q 30/0202

(52) U.S. Cl. CPC G06Q 10/087; G06Q 10/06315; G06Q 10/067; G06Q 30/0202

(57) ABSTRACT

In accordance with an embodiment, described herein are systems and methods for providing a supply chain command center for intelligent procurement assistance, based on an assessment of inventory trends, demand, or other inputs related to the procurement or management of an inventory of items. In accordance with an embodiment, the system can simultaneously optimize for a set of variables related to procurement, by creating time series forecasts of leaf-level independent variables, and performing a simulation within the boundary conditions of historical or expected distributions of each variable, to determine an optimal timing, quantity, location and/or vendor for each order of items that are to be placed in the inventory.

### CLAIM OF PRIORITY AND CROSS-REFERENCE TO RELATED APPLICATIONS

This application claims the benefit of priority to India Provisional Patent Application titled “SYSTEM AND METHOD FOR PROCUREMENT ASSISTANCE INCLUDING ASSESSMENT OF INVENTORY AND OTHER INPUTS”, application No. 202341064482, filed Sep. 26, 2023; and India Provisional Patent Application titled “SYSTEM AND METHOD FOR GENERATING ENTERPRISE ACCOUNTING FORECASTS BASED ON INPUT VARIABLES”, application No. 202341064658, filed Sep. 26, 2023; and is related to U.S. patent application titled “SYSTEM AND METHOD FOR GENERATING ENTERPRISE FORECASTS BASED ON INPUT VARIABLES”, Inventors Vikas Agrawal et al., application Ser. No. 18/680,384, filed May 31, 2024; each of which above applications and the contents thereof are herein incorporated by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments described herein are generally related to data analytics environments, and are particularly directed to systems and methods for providing a supply chain command center for intelligent procurement assistance based on an assessment of inventory trends, demand, or other inputs.

### BACKGROUND

Within an enterprise or other corporate environment, a procurement process for use in maintaining an inventory of items may exhibit significant performance problems including but not limited to sub-optimal quantity or lot sizes, sub-optimal item mix, sub-optimal price, sub-optimal timing, sub-optimal inventory position, or sub-optimal location.

Such procurement-related issues may result from an uninformed decision-making process that does not consider dynamic non-deterministic demand, unknown or changing lead times, manufacturing or retail disruptions, or fails to take advantage of seasonal, quantity, or contractual discounts. The resulting sub-optimality amounts to a substantial financial loss in the supply chain procurement process, as seen through the supply chain monitoring by procurement officers.

### SUMMARY

In accordance with an embodiment, described herein are systems and methods for providing a supply chain command center for intelligent procurement assistance, based on an assessment of inventory trends, demand, sales, costs, movement, transformation, or other inputs related to the procurement or management of an inventory of items.

In accordance with an embodiment, the system can simultaneously optimize for a set of variables related to procurement including upstream and downstream supply chain, by creating time series forecasts of leaf-level independent variables, and performing a simulation within the boundary conditions of historical or expected distributions of each variable, to determine an optimal timing, quantity, location and/or vendor for each order of items that are to be placed in the inventory.

In accordance with an embodiment, the described approach can be used, for example, to reduce the possibility of inventory stockouts, spoilage, delays, oversubscription of warehouses, costs for rapid shipment, costs for insurance, or loss of sales.

### BRIEF DESCRIPTION OF THE DRAWINGS

FIG. 1 illustrates an example data analytics system or environment, in accordance with an embodiment.

FIG. 2 further illustrates an example data analytics environment, in accordance with an embodiment.

FIG. 3 further illustrates an example data analytics environment, in accordance with an embodiment.

FIG. 4 further illustrates an example data analytics environment, in accordance with an embodiment.

FIG. 5 further illustrates an example data analytics environment, in accordance with an embodiment.

FIG. 6 further illustrates an example data analytics environment, in accordance with an embodiment.

FIG. 7 further illustrates an example data analytics environment, in accordance with an embodiment.

FIG. 8 illustrates an example use of a data analytics environment, in accordance with an embodiment.

FIG. 9 illustrates an example use of a procurement lifecycle, in accordance with an embodiment.

FIG. 10 further illustrates an example use of a procurement lifecycle, in accordance with an embodiment.

FIG. 11 further illustrates an example use of a procurement lifecycle, in accordance with an embodiment.

FIG. 12 illustrates a procurement data model or process as may be used with a supply chain command center, in accordance with an embodiment.

FIG. 13 further illustrates a procurement data model or process, in accordance with an embodiment.

FIG. 14 illustrates the use of a procurement data model or process, in accordance with an embodiment.

FIGS. 15A-15C further illustrate the use of a procurement data model or process, in accordance with an embodiment.

FIG. 16 illustrates an example user interface as may be used with a supply chain command center to provide intelligent procurement assistance, in accordance with an embodiment.

FIG. 17 further illustrates an example user interface, in accordance with an embodiment.

FIG. 18 illustrates the use of a supply chain command center, in accordance with an embodiment.

FIG. 19 further illustrates the use of a supply chain command center, in accordance with an embodiment.

FIG. 20 illustrates a process or method for providing intelligent procurement assistance, in accordance with an embodiment.

### DETAILED DESCRIPTION

Within an enterprise or other corporate environment, a procurement process for use in maintaining an inventory of items may exhibit significant performance problems including but not limited to sub-optimal quantity or lot sizes, sub-optimal item mix, sub-optimal price, sub-optimal timing, sub-optimal inventory position, or sub-optimal location.

Such procurement-related issues may result from an uninformed decision-making process that does not consider dynamic non-deterministic demand, unknown or changing lead times, manufacturing or retail disruptions, or fails to take advantage of seasonal, quantity, or contractual discounts. The resulting sub-optimality amounts to a substantial financial loss in the supply chain procurement process, as seen through the supply chain monitoring by procurement officers.

In accordance with an embodiment, described herein are systems and methods for providing a supply chain command center for intelligent procurement assistance, based on an assessment of inventory trends, demand, sales, costs, movement, transformation, or other inputs related to the procurement or management of an inventory of items.

In accordance with an embodiment, the system can simultaneously optimize for a set of variables related to procurement including upstream and downstream supply chain, by creating time series forecasts of leaf-level independent variables, and performing a simulation within the boundary conditions of historical or expected distributions of each variable, to determine an optimal timing, quantity, location and/or vendor for each order of items that are to be placed in the inventory.

In accordance with an embodiment, the described approach can be used, for example, to reduce the possibility of inventory stockouts, spoilage, delays, oversubscription of warehouses, costs for rapid shipment, costs for insurance, or loss of sales.

### Data Analytics Environments

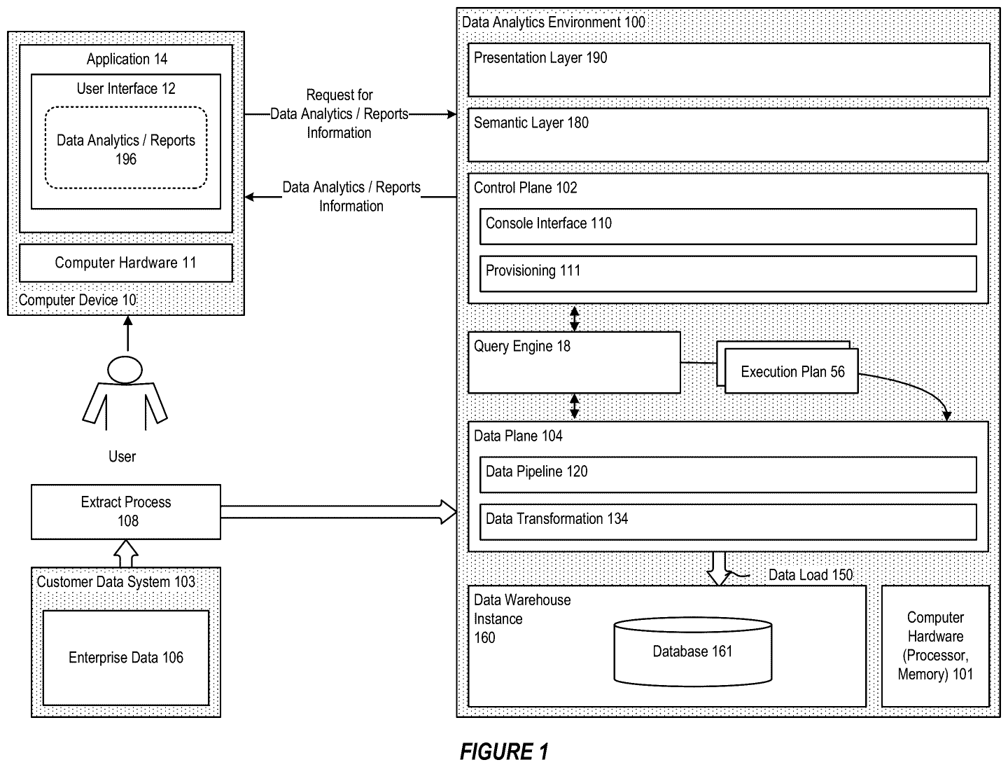

FIG. 1 illustrates an example data analytics system or environment, in accordance with an embodiment.

Examples of data analytics environments and business intelligence tools/servers include Oracle Business Intelligence Server (OBIS), Oracle Analytics Cloud (OAC), and Fusion Analytics Warehouse (FAW), which support features such as data mining or analytics, and analytic applications.

The example embodiment illustrated in FIG. 1 is provided for purposes of illustrating an example of a data analytics environment in association with which various embodiments described herein can be used. In accordance with other embodiments and examples, the approach described herein can be used with other types of data analytics, database, or data warehouse environments. The components and processes illustrated in FIG. 1, and as further described herein with regard to various other embodiments, can be provided as software or program code executable by, for example, a cloud computing system, or other suitably-programmed computer system.

As illustrated in FIG. 1, in accordance with an embodiment, a data analytics environment 100 can be provided by, or otherwise operate at, a computer system having a computer hardware (e.g., processor, memory) 101, and including one or more software components operating as a control plane 102, and a data plane 104, and providing access to a data warehouse, data warehouse instance 160 (database 161, or other type of data source).

In accordance with an embodiment, the control plane operates to provide control for cloud or other software products offered within the context of a SaaS or cloud environment, such as, for example, an Oracle Analytics Cloud environment, or other type of cloud environment. For example, in accordance with an embodiment, the control plane can include a console interface 110 that enables access by a customer (tenant) and/or a cloud environment having a provisioning component 111.

In accordance with an embodiment, the console interface can enable access by a customer (tenant) operating a graphical user interface (GUI) and/or a command-line interface (CLI) or other interface; and/or can include interfaces for use by providers of the SaaS or cloud environment and its customers (tenants). For example, in accordance with an embodiment, the console interface can provide interfaces that allow customers to provision services for use within their SaaS environment, and to configure those services that have been provisioned.

In accordance with an embodiment, a customer (tenant) can request via the console interface, a number of attributes associated with the data warehouse instance, including required attributes (e.g., login credentials), and optional attributes (e.g., size, or speed). The provisioning component can then provision the requested data warehouse instance, including a customer schema of the data warehouse; and populate the data warehouse instance with the appropriate information supplied by the customer. The provisioning component can also be used to update or edit a data warehouse instance, and/or an ETL process that operates at the data plane, for example, by altering or updating a requested frequency of ETL process runs, for a particular customer (tenant).

In accordance with an embodiment, the data plane can include a data pipeline or process layer 120 and a data transformation layer 134, that together process operational or transactional data from an organization's enterprise software application or data environment, such as, for example, business productivity software applications provisioned in a customer's (tenant's) SaaS environment. The data pipeline or process can include various functionality that extracts transactional data from business applications and databases that are provisioned in the SaaS environment, and then load a transformed data into the data warehouse.

In accordance with an embodiment, the data transformation layer can include a data model, such as, for example, a knowledge model (KM), or other type of data model, that the system uses to transform the transactional data received from business applications and corresponding transactional databases provisioned in the SaaS environment, into a model format understood by the data analytics environment.

In accordance with an embodiment, the data plane is responsible for performing extract, transform, and load (ETL) operations, including extracting transactional data from an organization's enterprise software application or data environment, such as, for example, business productivity software applications and corresponding transactional databases offered in a SaaS environment, transforming the extracted data into a model format, and loading the transformed data into a customer schema of the data warehouse.

For example, in accordance with an embodiment, each customer (tenant) of the environment can be associated with their own customer tenancy within the data warehouse, that is associated with their own customer schema; and can be additionally provided with read-only access to the data analytics schema, which can be updated by a data pipeline or process, for example, an ETL process, on a periodic or other basis.

In accordance with an embodiment, a data pipeline or process can be scheduled to execute at intervals (e.g., hourly/daily/weekly) to extract enterprise data 106 from a customer data system 103, for purposes of running data analytics thereon. For example, an extract process 108 can extract the transactional data, whereupon extraction the data pipeline or process can insert extracted data into a data staging area, which can act as a temporary staging area for the extracted data. A data quality component and data protection component can be used to ensure the integrity of the extracted data. For example, in accordance with an embodiment, the data quality component can perform validations on the extracted data while the data is temporarily held in the data staging area.

In accordance with an embodiment, when the extract process has completed its extraction, the data transformation layer can be used to begin the transform process, to transform the extracted data into a model format to be loaded into the customer schema of the data warehouse.

In accordance with an embodiment, the data pipeline or process can operate in combination with the data transformation layer to transform data into the model format. The mapping and configuration database can store metadata and data mappings that define the data model used by data transformation. The data and configuration user interface (UI) can facilitate access and changes to the mapping and configuration database.

In accordance with an embodiment, the data transformation layer can transform extracted data into a format suitable for loading into a customer schema of data warehouse, for example according to the data model. During the transformation, the data transformation can perform dimension generation, fact generation, and aggregate generation, as appropriate. Dimension generation can include generating dimensions or fields for loading into the data warehouse instance.

In accordance with an embodiment, after transformation of the extracted data, the data pipeline or process can execute a warehouse load procedure 150, to load the transformed data into the customer schema of the data warehouse instance. Subsequent to the loading of the transformed data into customer schema, the transformed data can be analyzed and used in a variety of additional business intelligence processes.

Different customers of a data analytics environment may have different requirements with regard to how their data is classified, aggregated, or transformed, for purposes of providing data analytics or business intelligence data, or developing software analytic applications. In accordance with an embodiment, to support such different requirements, a semantic layer 180 can include data defining a semantic model of a customer's data; which is useful in assisting users in understanding and accessing that data using commonly-understood business terms; and provide custom content to a presentation layer 190.

In accordance with an embodiment, a semantic model can be defined, for example, in an Oracle environment, as a BI Repository (RPD) file, having metadata that defines logical schemas, physical schemas, physical-to-logical mappings, aggregate table navigation, and/or other constructs that implement the various physical layer, business model and mapping layer, and presentation layer aspects of the semantic model.

In accordance with an embodiment, a customer may perform modifications to their data source model, to support their particular requirements, for example by adding custom facts or dimensions associated with the data stored in their data warehouse instance; and the system can extend the semantic model accordingly.

In accordance with an embodiment, the presentation layer can enable access to the data content using, for example, a software analytic application, user interface, dashboard, key performance indicators (KPI's); or other type of report or interface as may be provided by products such as, for example, Oracle Analytics Cloud, or Oracle Analytics for Applications.

In accordance with an embodiment, a query engine 18 (e.g., an OBIS instance) operates in the manner of a federated query engine to serve analytical queries or requests from clients within, e.g., an Oracle Analytics Cloud environment, directed to data stored at a database.

In accordance with an embodiment, the OBIS instance can push down operations to supported databases, in accordance with a query execution plan 56, wherein a logical query can include Structured Query Language (SQL) statements received from the clients; while a physical query includes database-specific statements that the query engine sends to the database to retrieve data when processing the logical query. In this way the OBIS instance translates business user queries into appropriate database-specific query languages (e.g., Oracle SQL, SQL Server SQL, DB2 SQL, or Essbase MDX). The query engine (e.g., OBIS) can also support internal execution of SQL operators that cannot be pushed down to the databases.

In accordance with an embodiment, a user/developer can interact with a client computer device 10 that includes a computer hardware 11 (e.g., processor, storage, memory), user interface 12, and client application 14. A query engine or business intelligence server such as OBIS generally operates to process inbound, e.g., SQL, requests against a database model, build and execute one or more physical database queries, process the data appropriately, and then return the data in response to the request.

To accomplish this, in accordance with an embodiment, the query engine or business intelligence server can include various components or features, such as a logical or business model or metadata that describes the data available as subject areas for queries; a request generator that takes incoming queries and turns them into physical queries for use with a connected data source; and a navigator that takes the incoming query, navigates the logical model and generates those physical queries that best return the data required for a particular query.

For example, in accordance with an embodiment, a query engine or business intelligence server may employ a logical model mapped to data in a data warehouse, by creating a simplified star schema business model over various data sources so that the user can query data as if it originated at a single source. The information can then be returned to the presentation layer as subject areas, according to business model layer mapping rules.

In accordance with an embodiment, the query engine (e.g., OBIS) can process queries against a database according to a query execution plan. During operation, the query engine or business intelligence server can create a query execution plan which can then be further optimized, for example to perform aggregations of data necessary to respond to a request. Data can be combined together, and further calculations applied, before the results are returned to the calling application.

In accordance with an embodiment, a request for data analytics or visualization information can be received via a client application and user interface as described above, and communicated to the analytics system (in the example of a cloud environment, via a cloud service). The system can retrieve an appropriate dataset to address the user/business context, for use in generating and returning the requested data analytics information 196 to the client.

In accordance with an embodiment, a client application can be implemented as software or computer-readable program code executable by a computer system or processing device, and having a user interface, such as, for example, a software application user interface or a web browser interface. The client application can retrieve or access data via an Internet/HTTP or other type of network connection to the analytics system, or in the example of a cloud environment via a cloud service provided by the environment.

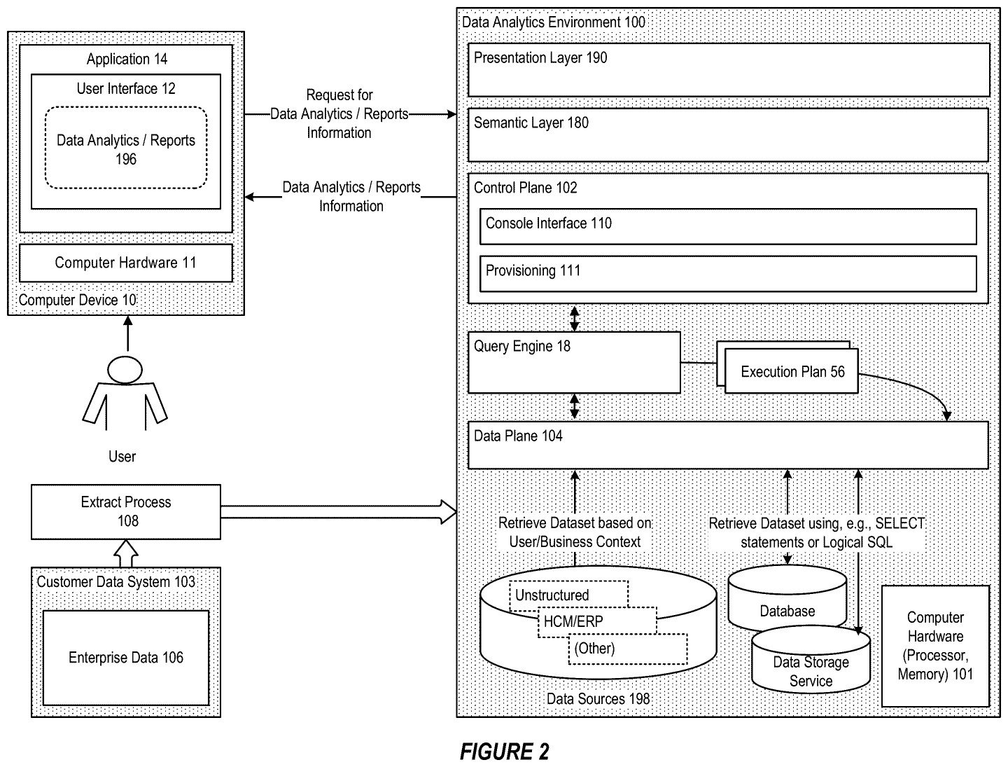

FIG. 2 further illustrates an example data analytics environment, in accordance with an embodiment.

As illustrated in FIG. 2, in accordance with an embodiment, the analytics system enables a dataset to be retrieved, received, or prepared from one or more data source(s) 198, for example via one or more data source connections. Examples of the types of data that can be transformed, analyzed, or visualized using the systems and methods described herein include HCM, HR, or ERP data, e-mail or text messages, or other of free-form or unstructured textual data provided at one or more of a database, data storage service, or other type of data repository or data source.

For example, in accordance with an embodiment, a request for data analytics or visualization information can be received via a client application and user interface as described above, and communicated to the analytics system (in the example of a cloud environment, via a cloud service). The system can retrieve an appropriate dataset to address the user/business context, for use in generating and returning the requested data analytics or visualization information to the client. For example, the data analytics system can retrieve a dataset using, e.g., SELECT statements or Logical SQL instructions.

In accordance with an embodiment, the system provides functionality that allows a user to generate datasets, analyses, or visualizations for display within a user interface, for example to explore datasets or data sourced from multiple data sources.

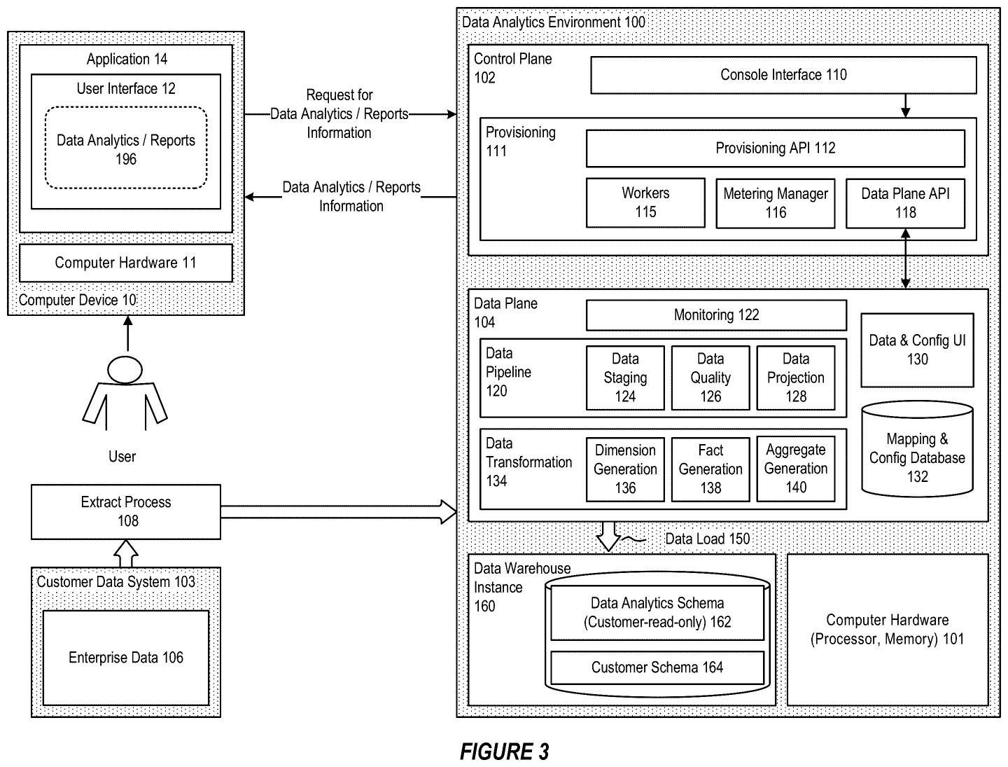

FIG. 3 further illustrates an example data analytics environment, in accordance with an embodiment.

As illustrated in FIG. 3, in accordance with an embodiment, the provisioning component can also comprise a provisioning application programming interface (API) 112, a number of workers 115, a metering manager 116, and a data plane API 118, as further described below. The console interface can communicate, for example, by making API calls, with the provisioning API when commands, instructions, or other inputs are received at the console interface to provision services within the SaaS environment, or to make configuration changes to provisioned services.

In accordance with an embodiment, the data plane API can communicate with the data plane. For example, in accordance with an embodiment, provisioning and configuration changes directed to services provided by the data plane can be communicated to the data plane via the data plane API.

In accordance with an embodiment, the metering manager can include various functionality that meters services and usage of services provisioned through control plane. For example, in accordance with an embodiment, the metering manager can record a usage over time of processors provisioned via the control plane, for particular customers (tenants), for billing purposes. Likewise, the metering manager can record an amount of storage space of data warehouse partitioned for use by a customer of the SaaS environment, for billing purposes.

In accordance with an embodiment, the data pipeline or process, provided by the data plane, can including a monitoring component 122, a data staging component 124, a data quality component 126, and a data projection component 128, as further described below.

In accordance with an embodiment, the data transformation layer can include a dimension generation component 136, fact generation component 138, and aggregate generation component 140, as further described below. The data plane can also include a data and configuration user interface 130, and mapping and configuration database 132.

In accordance with an embodiment, the data warehouse can include a default data analytics schema (referred to herein in accordance with some embodiments as an analytic warehouse schema) 162 and, for each customer (tenant) of the system, a customer schema 164.

In accordance with an embodiment, to support multiple tenants, the system can enable the use of multiple data warehouses or data warehouse instances. For example, in accordance with an embodiment, a first warehouse customer tenancy for a first tenant can comprise a first database instance, a first staging area, and a first data warehouse instance of a plurality of data warehouses or data warehouse instances; while a second customer tenancy for a second tenant can comprise a second database instance, a second staging area, and a second data warehouse instance of the plurality of data warehouses or data warehouse instances.

In accordance with an embodiment, based on the data model defined in the mapping and configuration database, the monitoring component can determine dependencies of several different data sets to be transformed. Based on the determined dependencies, the monitoring component can determine which of several different data sets should be transformed to the model format first.

For example, in accordance with an embodiment, if a first model dataset incudes no dependencies on any other model data set; and a second model data set includes dependencies to the first model data set; then the monitoring component can determine to transform the first data set before the second data set, to accommodate the second data set's dependencies on the first data set.

For example, in accordance with an embodiment, dimensions can include categories of data such as, for example, “name,” “address,” or “age”. Fact generation includes the generation of values that data can take, or “measures.” Facts can be associated with appropriate dimensions in the data warehouse instance. Aggregate generation includes creation of data mappings which compute aggregations of the transformed data to existing data in the customer schema of data warehouse instance.

In accordance with an embodiment, once any transformations are in place (as defined by the data model), the data pipeline or process can read the source data, apply the transformation, and then push the data to the data warehouse instance.

In accordance with an embodiment, data transformations can be expressed in rules, and once the transformations take place, values can be held intermediately at the staging area, where the data quality component and data projection components can verify and check the integrity of the transformed data, prior to the data being uploaded to the customer schema at the data warehouse instance. Monitoring can be provided as the extract, transform, load process runs, for example, at a number of compute instances or virtual machines. Dependencies can also be maintained during the extract, transform, load process, and the data pipeline or process can attend to such ordering decisions.

In accordance with an embodiment, after transformation of the extracted data, the data pipeline or process can execute a warehouse load procedure, to load the transformed data into the customer schema of the data warehouse instance. Subsequent to the loading of the transformed data into customer schema, the transformed data can be analyzed and used in a variety of additional business intelligence processes.

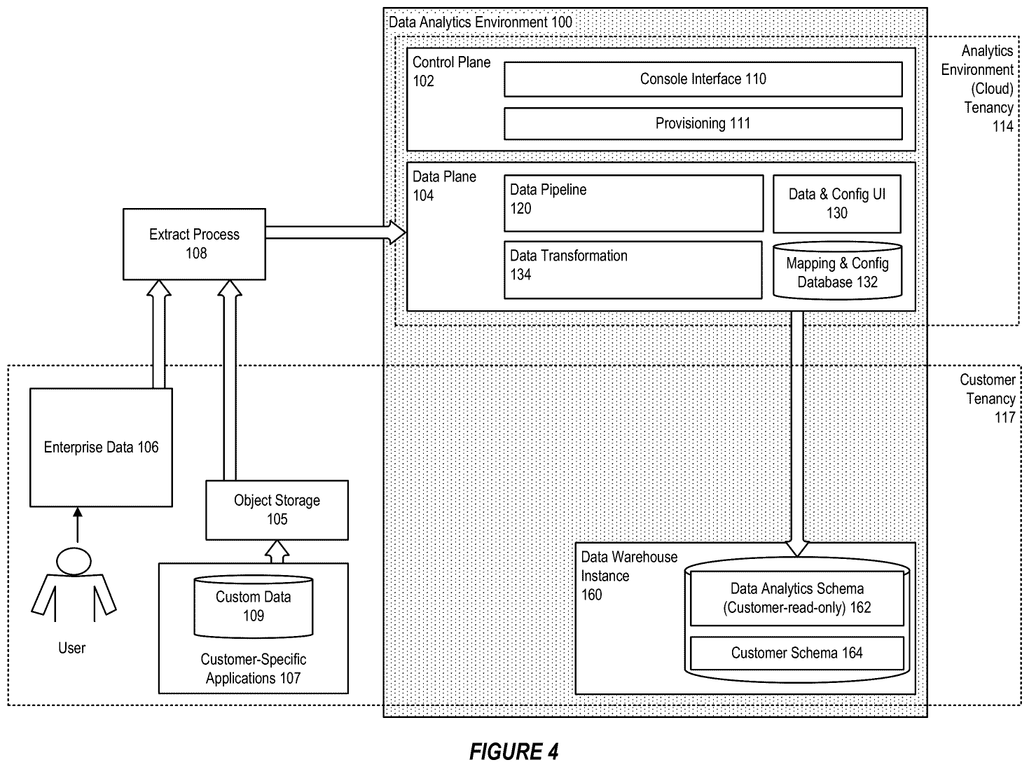

FIG. 4 further illustrates an example data analytics environment, in accordance with an embodiment.

As illustrated in FIG. 4, in accordance with an embodiment, data can be sourced, e.g., from a customer's (tenant's) enterprise data environment (106), using the data pipeline process; or as custom data 109 sourced from one or more customer-specific applications 107; and loaded to a data warehouse instance, including in some examples the use of an object storage 105 for storage of the data.

In accordance with embodiments of analytics environments such as, for example, Oracle Analytics Cloud (OAC), a user can create a data set that uses tables from different connections and schemas. The system uses the relationships defined between these tables to create relationships or joins in the data set.

In accordance with an embodiment, for each customer (tenant), the system uses the data analytics schema that is maintained and updated by the system, within a system/cloud tenancy 114, to pre-populate a data warehouse instance for the customer, based on an analysis of the data within that customer's enterprise applications environment, and within a customer tenancy 117. As such, the data analytics schema maintained by the system enables data to be retrieved, by the data pipeline or process, from the customer's environment, and loaded to the customer's data warehouse instance.

In accordance with an embodiment, the system also provides, for each customer of the environment, a customer schema that is readily modifiable by the customer, and which allows the customer to supplement and utilize the data within their own data warehouse instance. For each customer, their resultant data warehouse instance operates as a database whose contents are partly-controlled by the customer; and partly-controlled by the environment (system).

For example, in accordance with an embodiment, a data warehouse (e.g., ADW) can include a data analytics schema and, for each customer/tenant, a customer schema sourced from their enterprise software application or data environment. The data provisioned in a data warehouse tenancy (e.g., an ADW cloud tenancy) is accessible only to that tenant; while at the same time allowing access to various, e.g., ETL-related or other features of the shared environment.

In accordance with an embodiment, to support multiple customers/tenants, the system enables the use of multiple data warehouse instances; wherein for example, a first customer tenancy can comprise a first database instance, a first staging area, and a first data warehouse instance; and a second customer tenancy can comprise a second database instance, a second staging area, and a second data warehouse instance.

In accordance with an embodiment, for a particular customer/tenant, upon extraction of their data, the data pipeline or process can insert the extracted data into a data staging area for the tenant, which can act as a temporary staging area for the extracted data. A data quality component and data protection component can be used to ensure the integrity of the extracted data; for example by performing validations on the extracted data while the data is temporarily held in the data staging area. When the extract process has completed its extraction, the data transformation layer can be used to begin the transformation process, to transform the extracted data into a model format to be loaded into the customer schema of the data warehouse.

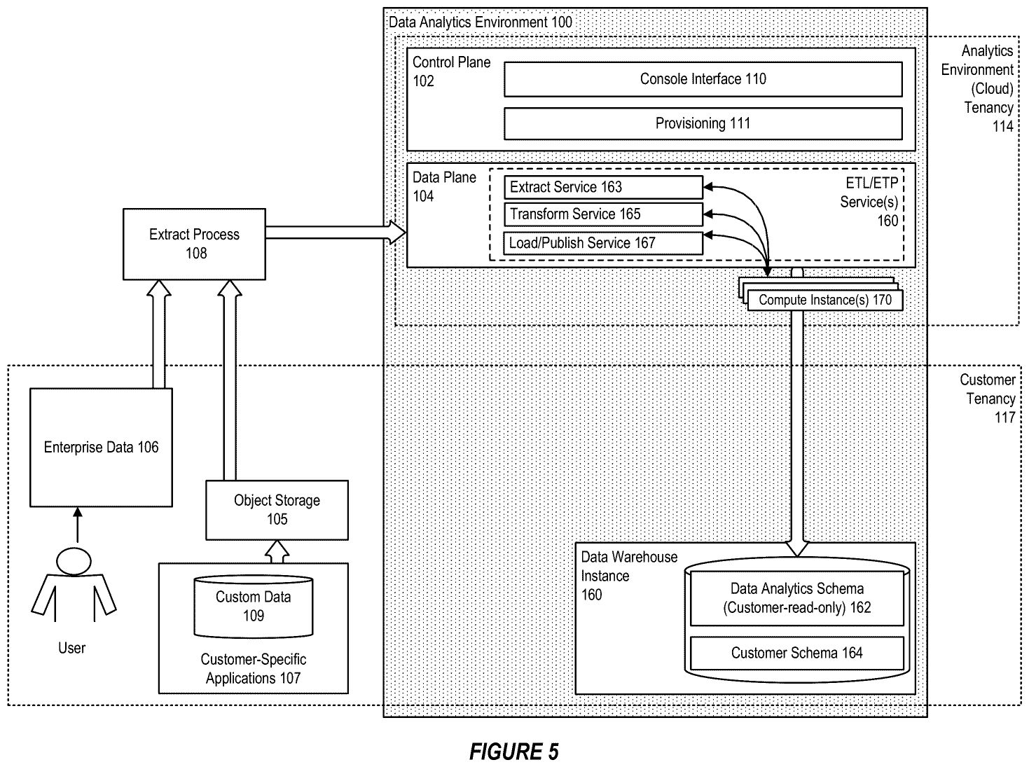

FIG. 5 further illustrates an example data analytics environment, in accordance with an embodiment.

As illustrated in FIG. 5, in accordance with an embodiment, the process of extracting data, e.g., from a customer's (tenant's) enterprise software application or data environment, using the data pipeline process as described above; or as custom data sourced from one or more customer-specific applications; and loading the data to a data warehouse instance, or refreshing the data in a data warehouse, generally involves three broad stages, performed by an ETP service 160 or process, including one or more extraction service 163; transformation service 165; and load/publish service 167, executed by one or more compute instance(s) 170.

For example, in accordance with an embodiment, a list of view objects for extractions can be submitted, for example, to an Oracle BI Cloud Connector (BICC) component via a ReST call. The extracted files can be uploaded to an object storage component, such as, for example, an Oracle Storage Service (OSS) component, for storage of the data. The transformation process takes the data files from object storage component (e.g., OSS), and applies a business logic while loading them to a target data warehouse, e.g., an ADW database, which is internal to the data pipeline or process, and is not exposed to the customer (tenant). A load/publish service or process takes the data from the, e.g., ADW database or warehouse, and publishes it to a data warehouse instance that is accessible to the customer (tenant).

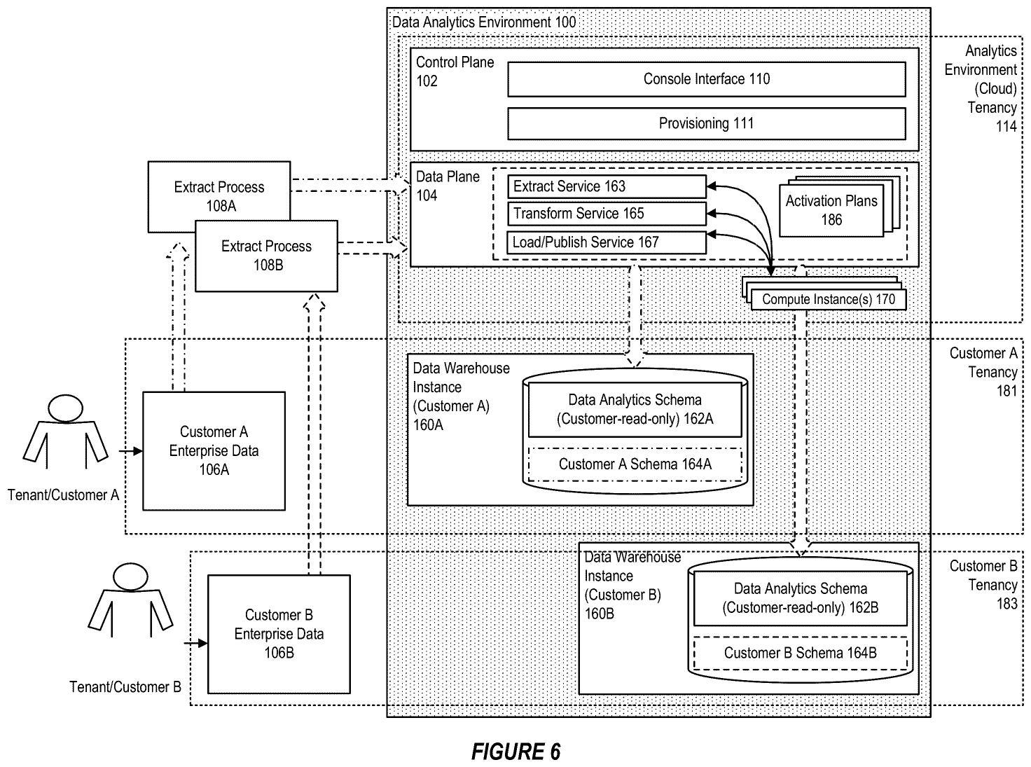

FIG. 6 further illustrates an example data analytics environment, in accordance with an embodiment.

As illustrated in FIG. 6, which illustrates the operation of the system with a plurality of tenants (customers) in accordance with an embodiment, data can be sourced, e.g., from each of a plurality of customer's (tenant's) enterprise software application or data environment, using the data pipeline process as described above; and loaded to a data warehouse instance.

In accordance with an embodiment, the data pipeline or process maintains, for each of a plurality of customers (tenants), for example customer A, customer B, a data analytics schema that is updated on a periodic basis, by the system in accordance with best practices for a particular analytics use case.

In accordance with an embodiment, for each of a plurality of customers (e.g., customers A, B), the system uses the data analytics schema 162A, 162B, that is maintained and updated by the system, to pre-populate a data warehouse instance for the customer, based on an analysis of the enterprise data 106A, 106B within that customer's enterprise application environment, and within each customer's tenancy (e.g., customer A tenancy 181, customer B tenancy 183); so that data is retrieved, by the data pipeline or process, from the customer's environment, and loaded to the customer's data warehouse instance 160A, 160B.

In accordance with an embodiment, the data analytics environment also provides, for each of a plurality of customers of the environment, a customer schema (e.g., customer A schema 164A, customer B schema 164B) that is readily modifiable by the customer, and which allows the customer to supplement and utilize the data within their own data warehouse instance.

As described above, in accordance with an embodiment, for each of a plurality of customers of the data analytics environment, their resultant data warehouse instance operates as a database whose contents are partly-controlled by the customer; and partly-controlled by the data analytics environment (system); including that their database appears pre-populated with appropriate data that has been retrieved from their enterprise applications environment to address various analytics use cases. When the extract process 108A, 108B for a particular customer has completed its extraction, the data transformation layer can be used to begin the transformation process, to transform the extracted data into a model format to be loaded into the customer schema of the data warehouse.

In accordance with an embodiment, activation plans 186 can be used to control the operation of the data pipeline or process services for a customer, for a particular functional area, to address that customer's (tenant's) particular needs.

For example, in accordance with an embodiment, an activation plan can define a number of extract, transform, and load (publish) services or steps to be run in a certain order, at a certain time of day, and within a certain window of time.

In accordance with an embodiment, each customer can be associated with their own activation plan(s). For example, an activation plan for a first Customer A can determine the tables to be retrieved from that customer's enterprise software application environment (e.g., their Fusion Applications environment), or determine how the services and their processes are to run in a sequence; while an activation plan for a second Customer B can likewise determine the tables to be retrieved from that customer's enterprise software application environment, or determine how the services and their processes are to run in a sequence.

### Supply Chain Command Center for Intelligent Procurement Assistance

Within an enterprise or other corporate environment, a procurement process for use in maintaining an inventory of items may exhibit significant performance problems including but not limited to sub-optimal quantity or lot sizes, sub-optimal item mix, sub-optimal price, sub-optimal timing, sub-optimal inventory position, or sub-optimal location.

Such procurement-related issues may result from an uninformed decision-making process that does not consider dynamic non-deterministic demand, unknown or changing lead times, manufacturing or retail disruptions, or fails to take advantage of seasonal, quantity, or contractual discounts. The resulting sub-optimality can amount to a substantial financial loss in the supply chain procurement process, as seen through the supply chain monitoring by procurement officers.

In accordance with an embodiment, described herein are systems and methods for providing a supply chain command center for intelligent procurement assistance, based on an assessment of inventory trends, demand, sales, costs, movement, transformation, or other inputs related to the procurement or management of an inventory of items.

In accordance with an embodiment, the system can simultaneously optimize for a set of variables related to procurement including upstream and downstream supply chain, by creating time series forecasts of leaf-level independent variables, and performing a simulation within the boundary conditions of historical or expected distributions of each variable, to determine an optimal timing, quantity, location and/or vendor for each order of items that are to be placed in the inventory.

In accordance with an embodiment, the described approach can be used, for example, to reduce the possibility of inventory stockouts, spoilage, delays, oversubscription of warehouses, costs for rapid shipment, costs for insurance, or loss of sales.

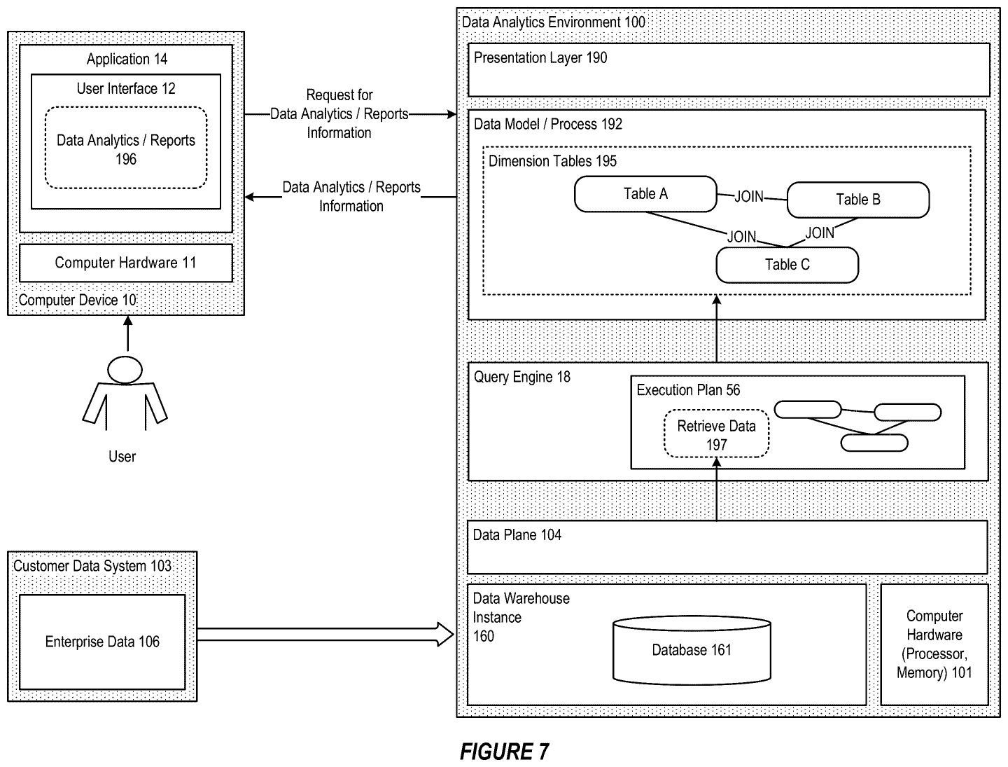

FIG. 7 further illustrates an example data analytics environment, in accordance with an embodiment.

As illustrated in FIG. 7, in accordance with an embodiment, data may be provided in one or more data tables, wherein the system can use a data model or process 192, joins, or other functionality, to retrieve 197 data from various tables 195.

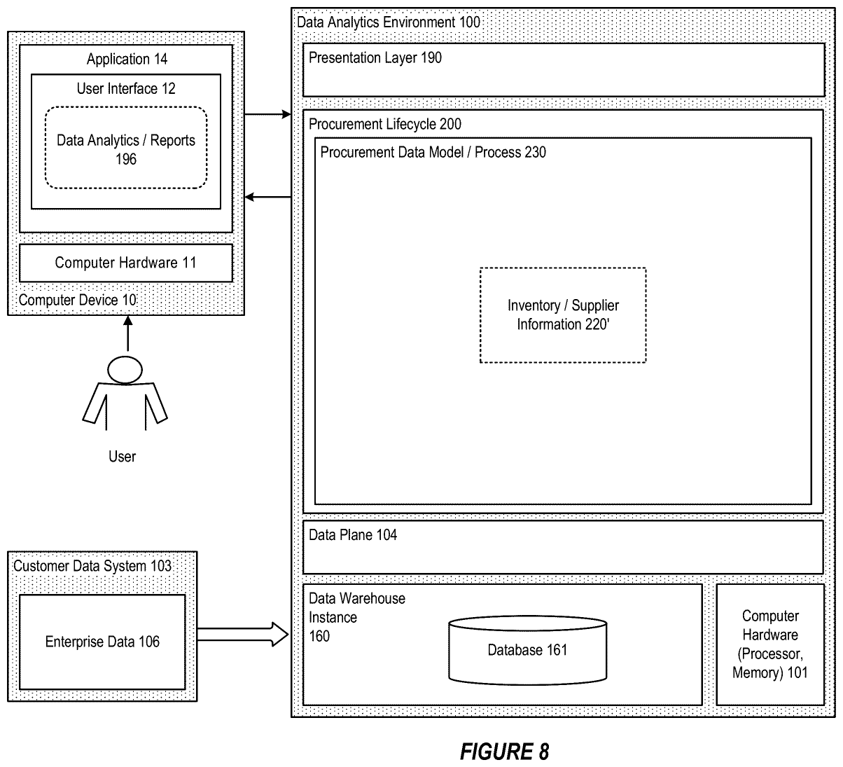

FIG. 8 illustrates an example use of a data analytics environment, in accordance with an embodiment.

As illustrated in FIG. 8, in accordance with an embodiment, the data analytics environment can be used in combination with, for example, a procurement data model or process 230, that considers inventory and supplier data or information 220 as part of a procurement lifecycle 200, as further described below.

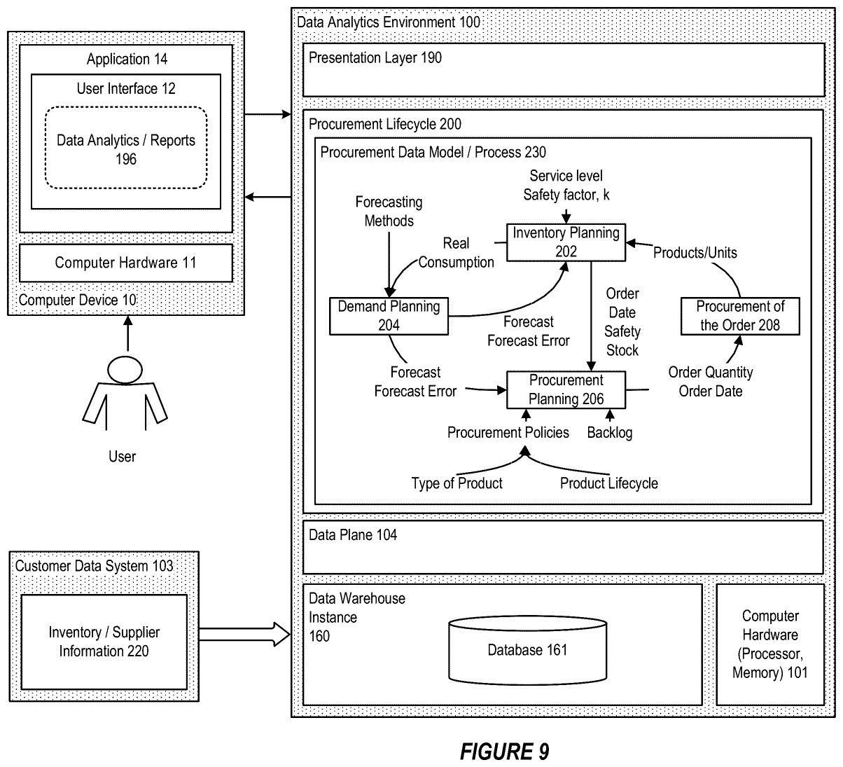

FIGS. 9-11 illustrate an example use of a procurement lifecycle, in accordance with an embodiment.

Within an organization, for example a company or other corporate environment, the procurement of inventory items may be performed on an ad-hoc basis. For example, different companies may have a variety of different procurement systems and operators. Each of these operators may manage their own inventories of items, and negotiate orders by themselves, leading to little consistency or loss of savings company-wide.

As illustrated in FIG. 9, in accordance with an embodiment, a procurement lifecycle 200 can include, for example, an inventory planning component 202, a demand planning component 204, and a procurement planning component 206, the data or information from which can be collectively used by an order procurement component 208.

For example, in accordance with an embodiment, the inventory planning component can receive as input a data defining a target service level, and safety factor, k, which together determine a desired level of inventory for each of a plurality of inventory items.

In accordance with an embodiment, the demand planning component can receive as input data one or more forecasting method's outputs, together with an indication of item consumption provided by the inventory planning component.

In accordance with an embodiment, the procurement planning component can receive as input data a set of procurement policies and models directed to the types of items (e.g., products and product lifecycles) within an inventory, together with an indication of planned order dates and safety stock levels provide by the inventory planning component.

In accordance with an embodiment, the order procurement component can receive as input data an indication of order quantity and order data, and/or when an order has been completed (received and inventoried), and then update the inventory planning component, for example with an indication of product or units thereof, as appropriate.

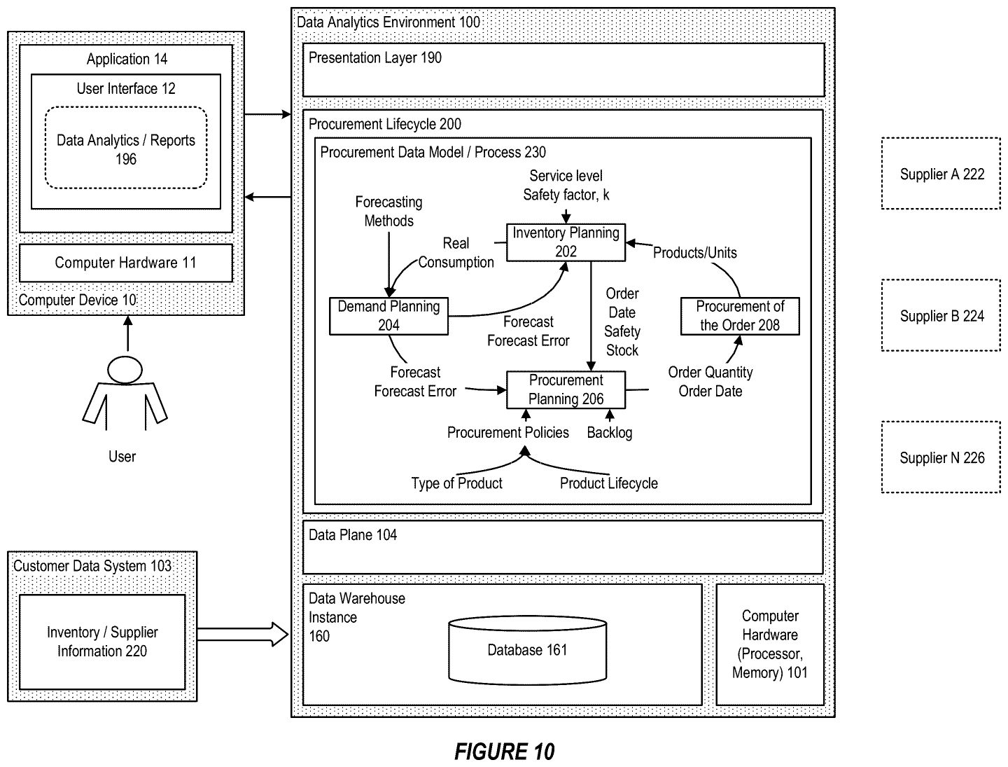

As illustrated in FIG. 10, in accordance with an embodiment, the system can receive, for example from a customer data system, an inventory and supplier data or information 220 for purposes of providing procurement assistance, including for example an indication of suppliers A 222, B 224, and N 226 that can provide a particular item, such as a product or units thereof.

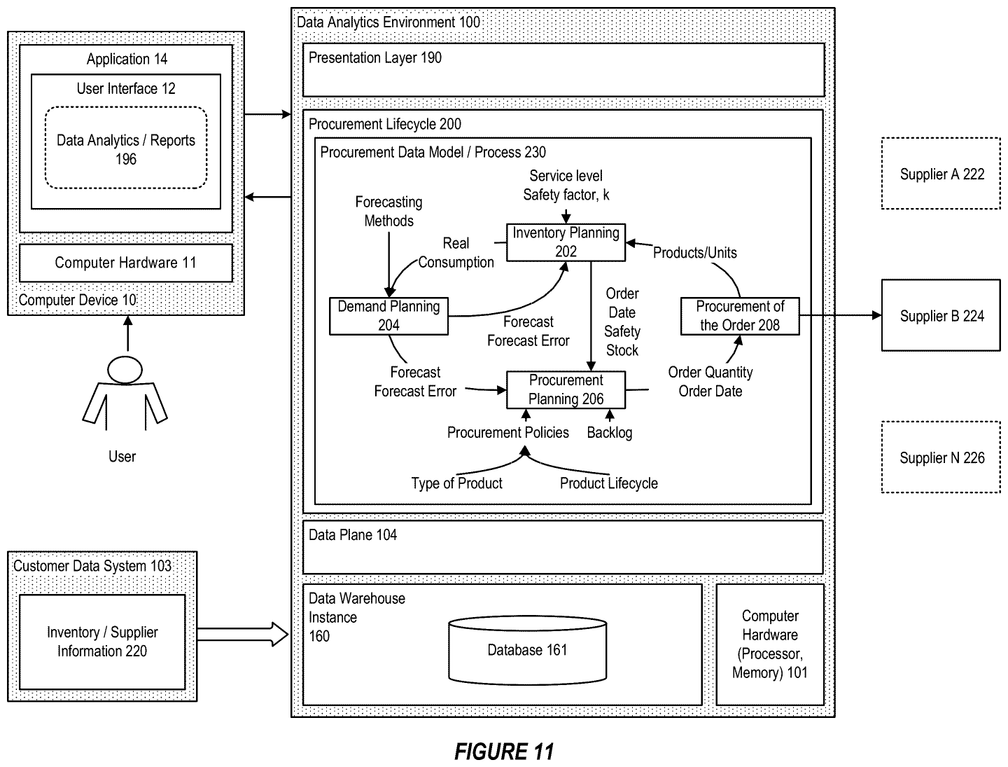

As illustrated in FIG. 11, in accordance with an embodiment, when it is determined by the system that an inventory position is less than a safety stock level, then the system can determine an order to be placed, including for example performing a simulation to find a lowest cost associated with the order, while achieving a target service level, and then directing the order to the most cost and quality effective supplier, in this example supplier B.

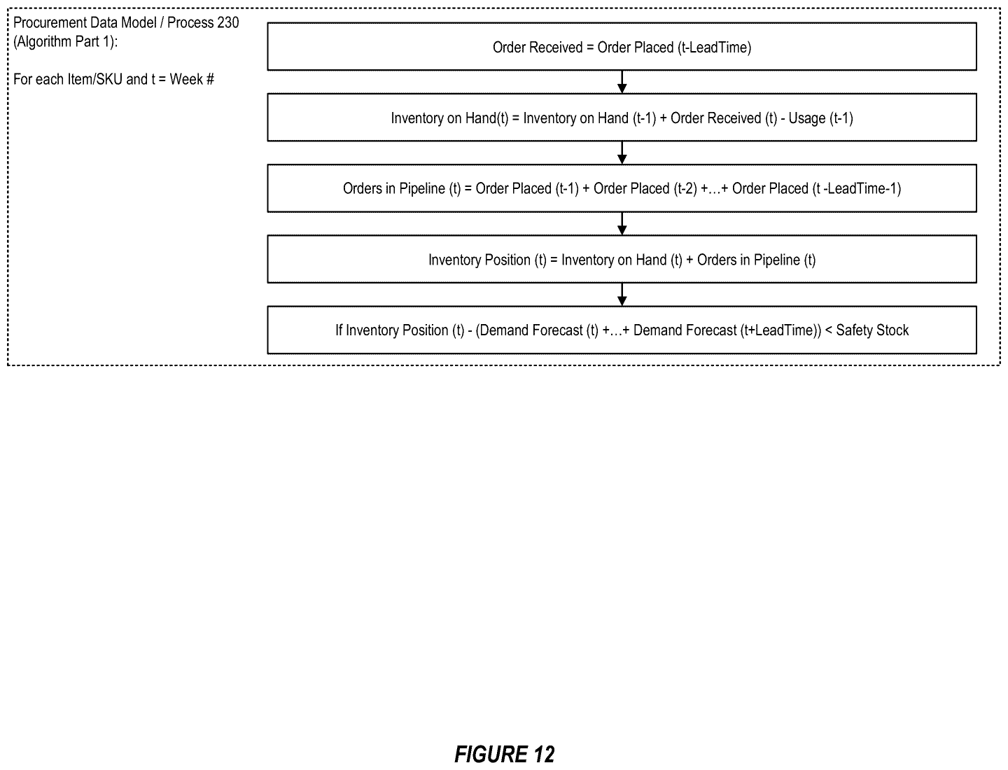

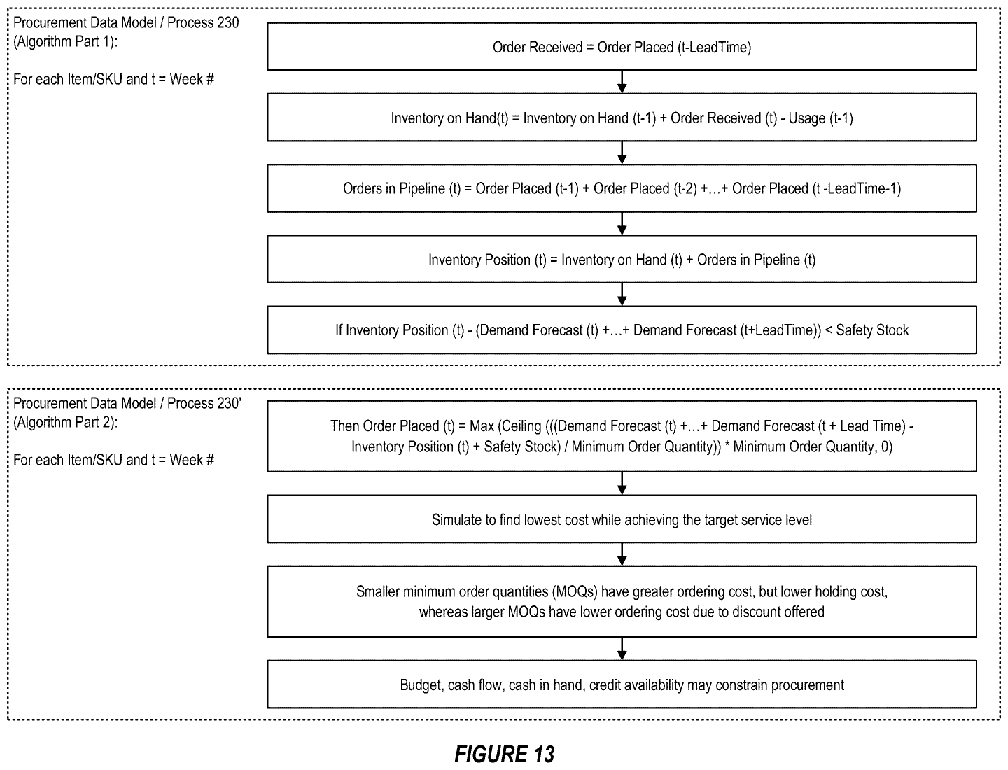

FIGS. 12-13 illustrate a procurement data model or process as may be used with a supply chain command center, in accordance with an embodiment.

In accordance with an embodiment, the system maintains a procurement data model or process which receives data or information from multiple sources, for example from a demand forecast system, a historical inventory data, or data or information on shipments, handling costs, cost of goods, and discounts, directly from suppliers. Based on this data or information the system can then calculate a cost associated with an inventory and orders to be placed.

For example, having too much stock on hand may not be cost effective or result in spoilage. As an inventory changes to reflect demand and usage, the system can optimize the performance of the procurement data model to take these things into account.

As illustrated in FIG. 12, in accordance with an embodiment, the procurement data model or process 230 can include, in a first part of a process or algorithm, for each item/SKU and (t)=Week # or Month #:

$$Order Received = Order Placed ( t - Lead Time )$$

$$Inventory on Hand ( t ) = Inventory on Hand ( t - 1 ) + Order Received ( t ) - Usage ( t - 1 )$$

$$Orders in Pipeline ( t ) = Order Placed ( t - 1 ) + Order Placed ( t - 2 ) + … + Order Placed ( t - Lead Time - 1 )$$

$$Inventory Position ( t ) = Inventory on Hand ( t ) + Order s in Pipeline ( t )$$

$$If Inventory Position ( t ) - ( Demand Forecast ( t ) + … + Demand Forecast ( t + Lead Time ) ) < Safety Stock$$

As illustrated by the above process or algorithm, in accordance with an embodiment, the system can use the procurement data model to, for example, calculate orders received; calculate inventory on hand; calculate orders in pipeline; and calculate an inventory position. If, based on assessing the procurement data model, the system determines that the inventory position minus demand forecast for a next week and following weeks is less than a safety stock, then the process proceeds to the following step.

As illustrated in FIG. 13, in accordance with an embodiment, the procurement data model or process can include, in a second part of the process or algorithm, for each item/SKU and (t)=Week # or Month #:

$$Order Placed ( t ) = Max ( ceiling ( ( ( Demand Forecast ( t ) + … + Demand Forecast ( t + Lead Time ) - Inventory Position ( t ) + Safety Stock ) / Minimum Order Quantity ) ) * Minimum Order Quantity , 0 )$$

Which above expression can alternatively be represented as:

$$Order Placed ( t ) = Max ( ⌈ ( Demand Forecast ( t ) + … + Demand Forecast ( t + Lead Time ) - Inventory Position ( t ) + Safety Stock ) / Minimum Order Quantity ⌉ * Minimum Order Quantity , 0 )$$

Simulate to find lowest cost while achieving the target service level.

Smaller minimum order quantities (MOQs) have a greater ordering cost, but lower holding cost, whereas larger MOQs have a lower ordering cost due to the discount offered.

Budget, cash flow/cash in hand, credit availability may constrain procurement.

In accordance with an embodiment, as represented by the above expression:
1. The innermost part, (Demand Forecast (t)+ . . . +Demand Forecast (t+Lead Time)−Inventory Position (t)+Safety Stock), calculates the adjusted demand forecast over the lead time period.
2. This is divided by the Minimum Order Quantity.
3. The ceiling function is applied to this division.
4. Finally, the result is multiplied by the Minimum Order Quantity.
5. The maximum of this value and 0 is taken to determine the order placed at time t.

In accordance with an embodiment, inputs to the procurement data model can include, for example: a weekly demand forecast for, e.g., a 12-month timeframe, obtained from the waterfall forecast for high, medium and low demand stock-keeping units (SKUs); a current inventory level for each week from the historical inventory trend (HIT) data; safety stock target details for each SKU from the HIT data; historical inventory usage obtained from the HIT data; a lead time for replenishment for each item for each supplier; a target service level that was agreed upon by the executives at the company; and a total ordering cost, holding cost, stockout cost, shipping cost, and insurance cost.

As illustrated by the above process or algorithm, in accordance with an embodiment, the system can first calculate the order size, by assessing a value for (maximum demand-inventory stock) in a particular week. If the result is determined to be negative, then there is no need to order any items at this time, because the results suggests the inventory has sufficient stock to meet the anticipated maximum demand. Otherwise, the system can proceed to the next step to determining an order to placed, including amount, supplier and/or other criteria.

In accordance with an embodiment, the system performs a simulation to find a lowest cost while achieving the target item level. For example, in accordance with an embodiment, a dynamical network programming model can be used to balance a larger minimum order quantity MOQ (lower order cost because discount) versus a smaller order quantity (higher order cost but lower holding cost).

In accordance with an embodiment, the simulation can also consider factors such as a supplier administrative lead time, receive item lead time, or cash flow projection. An example of such environment is described in co-pending U.S. patent application titled “SYSTEM AND METHOD FOR GENERATING ENTERPRISE FORECASTS BASED ON INPUT VARIABLES”, Inventors Vikas Agrawal et al., application Ser. No. 18/680,384, filed May 31, 2024, which application and the contents thereof are herein incorporated by reference.

In some instances, it may be desired for the inventory to have a safety stock on hand. For example, if the predicted inventory position is less than a safety stock then we need to order; while considering the cash flow position and budget constraints.

In accordance with an embodiment, once the system has determined that an order should be placed, it can proceed to calculate an optimal order quantity to meet the target service level, for example to optimize the amount of stock on hand to meet the anticipated workflow.

In accordance with an embodiment, in optimizing the order quantity, the system can, for example, calculate an order in the nearest incremental multiple of MOQ (minimum order quantity) for a supplier to take advantage of discounts and lower holding costs while ensuring no stockout. The process or algorithm can also consider factors such as what happens when there is an item price change forecast, which may provide an opportunistic price-driven purchase prediction.

In accordance with an embodiment, the model can be run (i.e., provide a granularity) on a weekly or other periodic basis, for example to automatically calculate the procurement data or information on a weekly basis and provide to the operator various scenarios in a user interface.

In accordance with an embodiment, simulation and optimization techniques can include grid search mechanisms, Monte Carlo simulations, or other techniques that allow for setting boundary conditions and searching within the space of controllable input variables.

The above examples of data inputs are provided by way of example and for purpose of illustration of the features and processes described herein; in accordance with various embodiments, the procurement assistant as described herein can utilize other types of input data or information as part of its analysis.

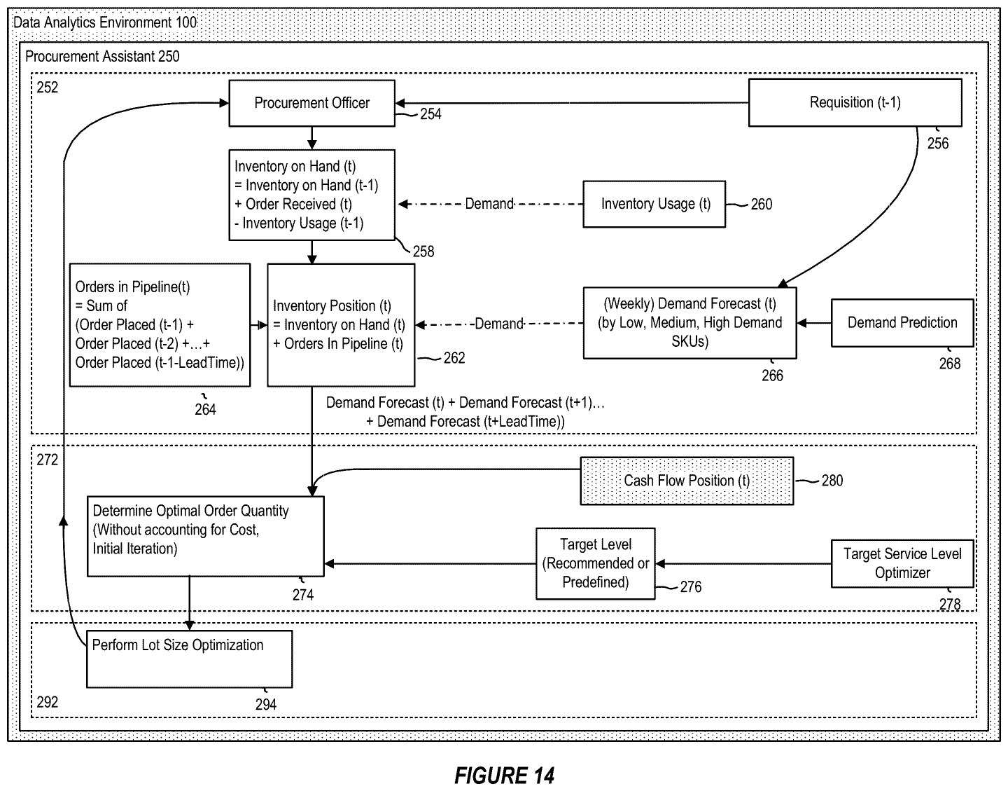

FIG. 14 illustrates the use of a procurement data model or process, in accordance with an embodiment.

As illustrated in FIG. 14, in accordance with an embodiment, a procurement assistant 250 can operate according to a procurement data model or process over multiple phases.

In accordance with an embodiment, in a first phase 252, under direction of a procurement officer 254, the system can, for each item within an inventory, and a particular time period (t): determine the inventory on hand 258, a present inventory usage (t) 260, and orders currently in the pipeline 264, in order to determine an inventory position 262.

In accordance with an embodiment, a demand forecast 266, for example as provided by a demand prediction component 268 and considering any prior requisition 256, can be used to supplement the inventory position.

In accordance with an embodiment, in a second phase 272, the system can determine, for example, that an inventory position is less than a safety stock level, and in response thereto, for each item within the inventory, and particular time period, determine an order to be placed.

In accordance with an embodiment, an order quantity component 274 can receive an input as to target level 276, for example from a target service level optimizer 278. An enterprise or accounting forecast, for example a cash flow position 280, can also be provided for use in determining an optimal order quantity, based on cash on hand and competing priorities of expense corporation-wide.

In accordance with an embodiment, in a third phase 292, the system can perform a simulation, for example by means of a lot size optimization component 294, to find a lowest cost associated with the order, while achieving a target service level.

In accordance with an embodiment, the system includes a procurement assistant component or process that operates to simulate the below process or algorithm with different values of variables in a Monte Carlo simulation, to find a lowest cost (optimization) while achieving the target service level constrained by, for example, budget, cash flow/cash in hand, and credit availability.

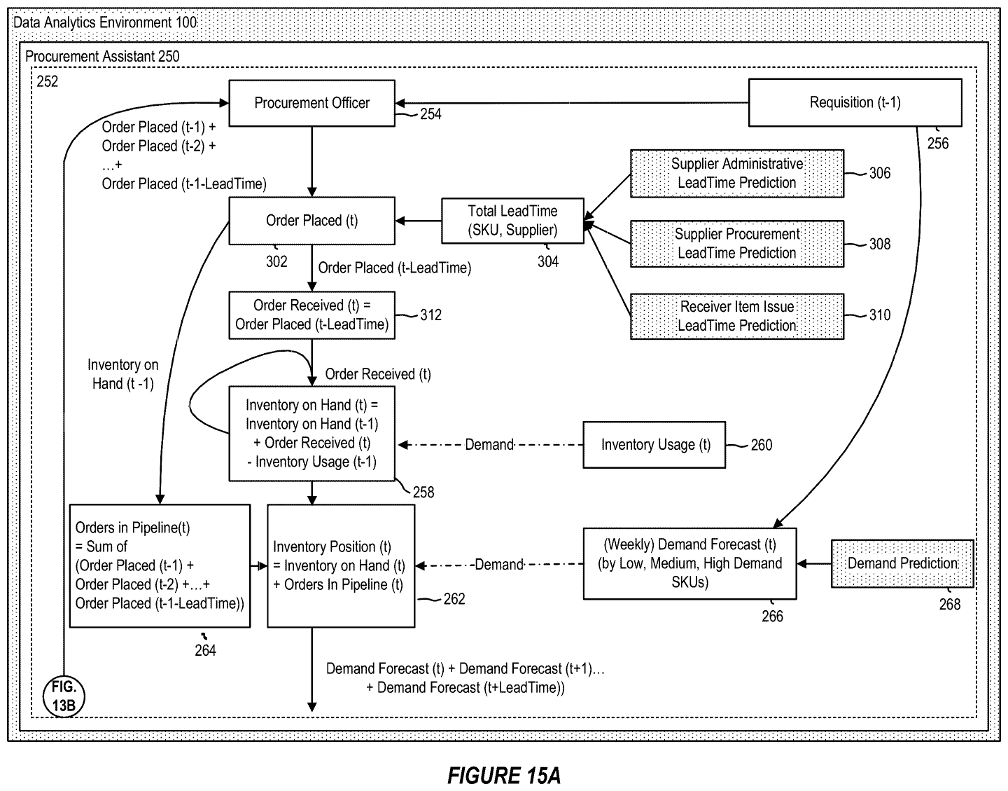

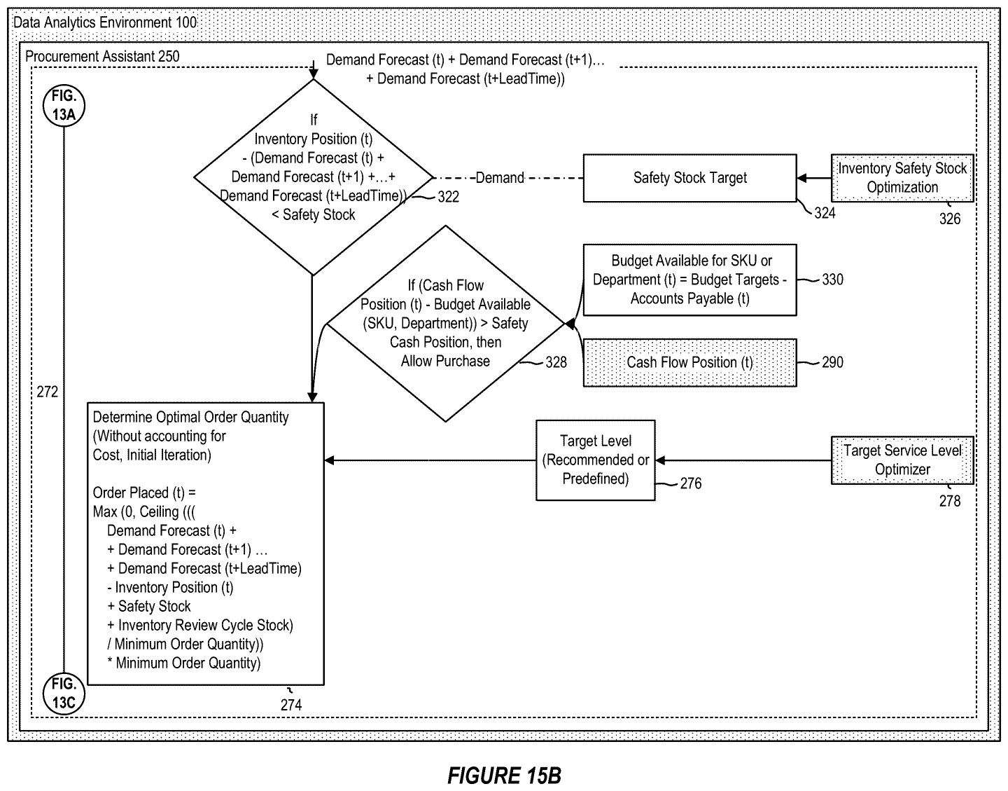

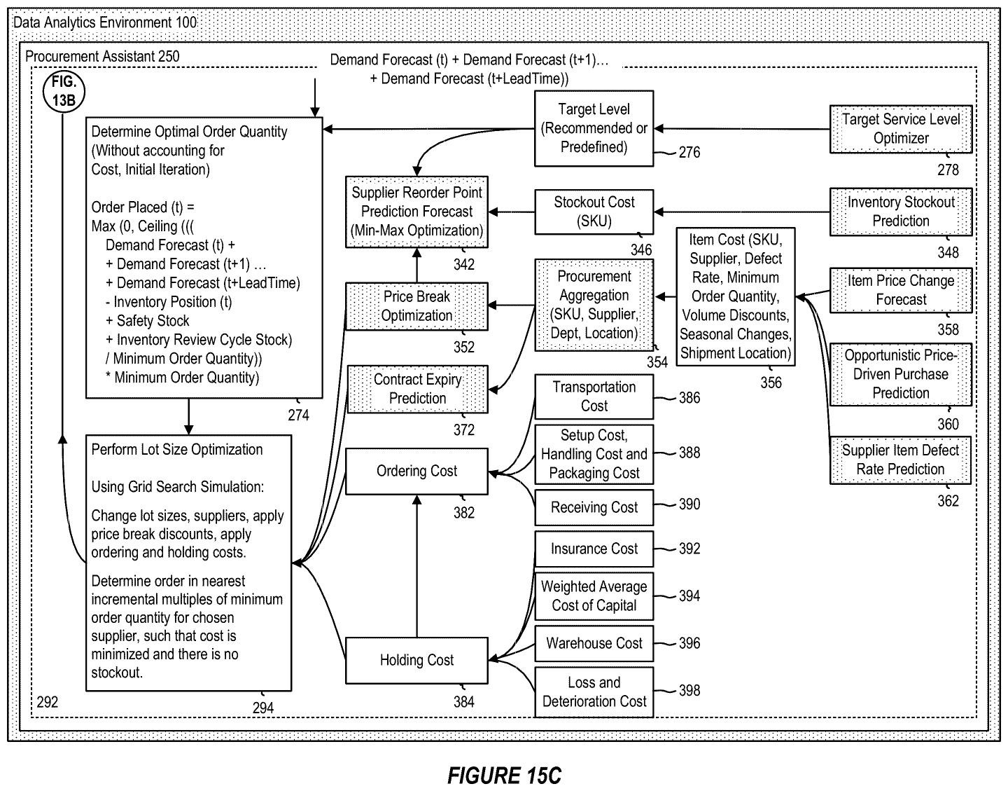

FIGS. 15A-15C further illustrate the use of a procurement data model or process, in accordance with an embodiment.

As illustrated in FIG. 15A, in accordance with an embodiment, during the first phase of the procurement assistant process, the determination of order placed (t) 302 and order received (t) 312 is dependent on the total lead time 304, data or information for which can be provided by a combination of one or more supplier administrative lead time prediction 306, supplier procurement lead time prediction 308, or receiver item issue lead-time prediction 310 components; wherein an order received (t) is equal to order placed (t-lead time).

As illustrated in FIG. 15B, in accordance with an embodiment, during the second phase of the procurement assistant process, in order to determine an optimal order quantity, the processed can take into account whether an Inventory Position (t)−(Demand Forecast (t)+Demand Forecast (t+1)+ . . . +Demand Forecast (t+LeadTime))<Safety Stock (322), using data or information described a safety stock target 324 as received by an inventory safety stock optimization component 326.

In accordance with an embodiment, the process can take into account an enterprise or accounting forecast such as cash flow position, wherein for example, if (cash flow position (t)−budget available)>safety cash position, then allow purchase (328), wherein the budget available for SKU or department (t)=budget targets-accounts payable (t) (330) and using a cash flow position data or information as described above.

As illustrated in FIG. 15C, in accordance with an embodiment, during the third phase of the procurement assistant process, in order to perform a lot size optimization, the system can receive data or information such as supply reorder point prediction forecast 342, using data or information such as stockout cost 346 provided by an inventory stockout prediction component 348. Data or information provided by components such as price break optimization 352 and contract expiry prediction 372 can use data or information provided by a procurement aggregation component 354, which in turn receives data or information such as item cost 356 from item price change forecast 358, opportunistic price driven purchase prediction 360, and supplier item defect rate prediction 362 components.

In accordance with an embodiment, the optimization of lot size can also consider ordering cost 382, as determined by transportation cost 386, setup cost 388, receiving cost 390; and holding cost 384 as determined by insurance cost 392, weighted average cost of capital 394, warehouse cost 396, and loss and deterioration cost 398.

In the example supply chain command center for intelligent procurement assistance described above, various components can be provided within the system itself, or can be provided as separate applications or systems that feed data or information into the process.

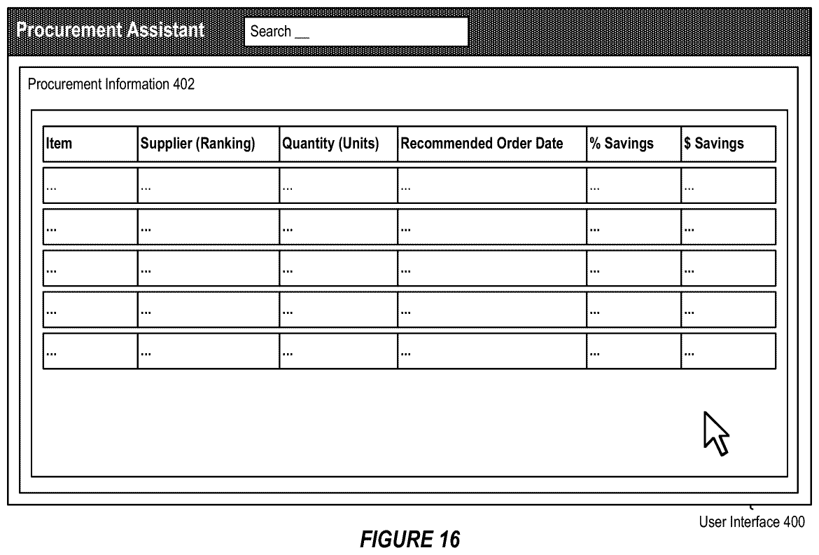

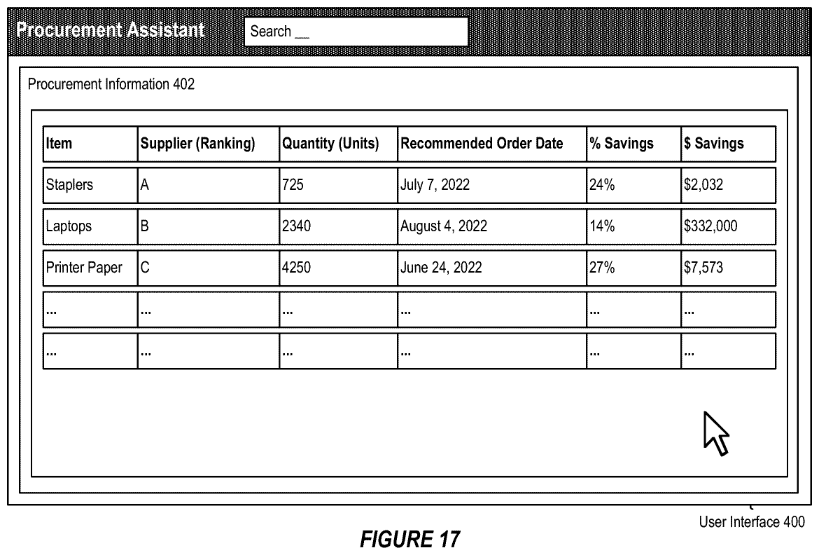

FIGS. 16-17 illustrate an example user interface as may be used with a supply chain command center to provide intelligent procurement assistance, in accordance with an embodiment.

As illustrated in FIG. 16, in accordance with an embodiment, once the data or information has been processed, the system can generate or display a user interface 400, for example as a procurement assistance for use by a procurement officer that displays items, supplier (ranking) quantity (units) recommended order date, and savings. The system may also display supply delays, items out of stock, overstocked items, losses, and savings.

As illustrated in FIG. 17, in accordance with an embodiment, by way of example, the system can determine orders for items such as staplers, laptops, and printer paper, together with suppliers and recommend order quantities and dates.

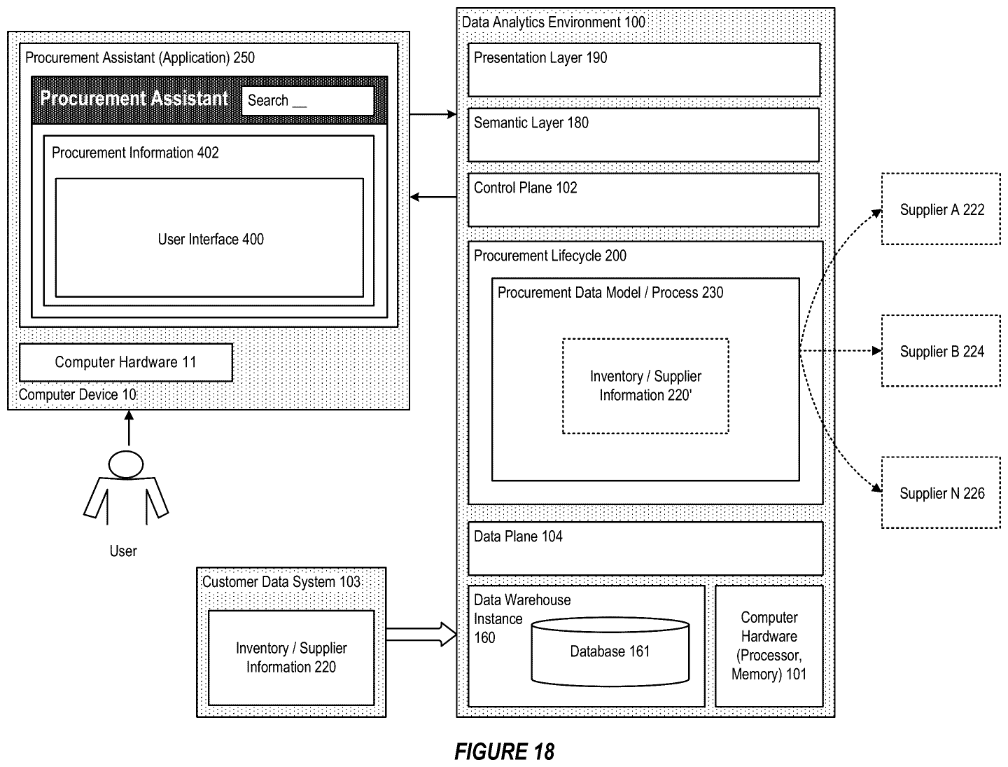

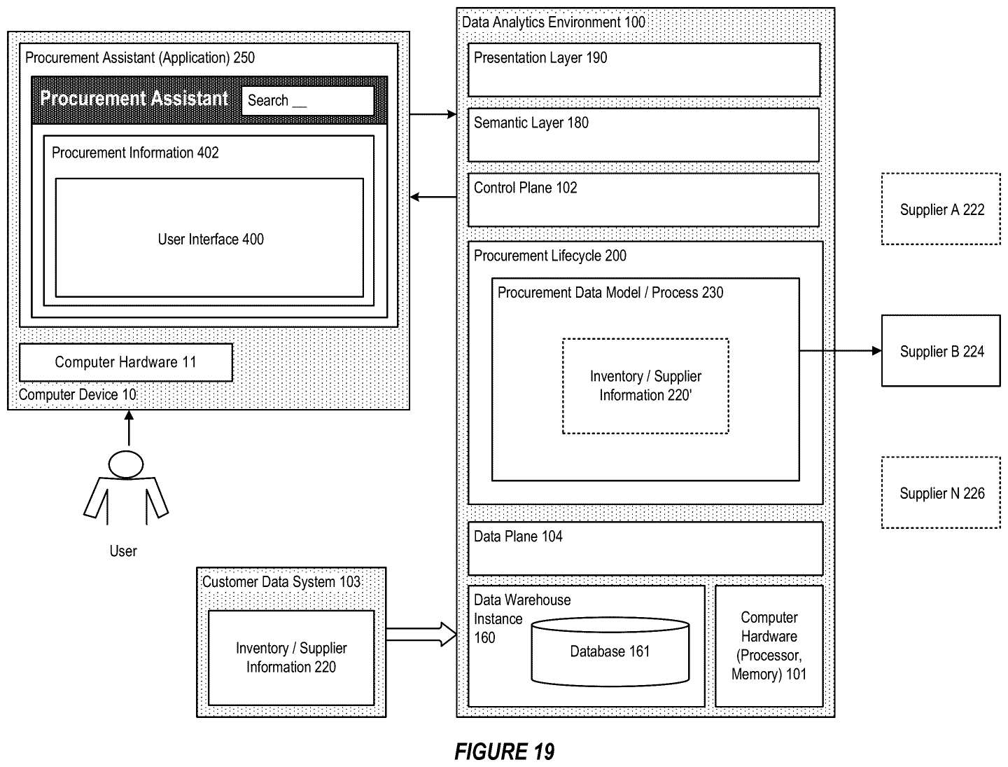

FIGS. 18-19 illustrate the use of a supply chain command center, in accordance with an embodiment.

As illustrated in FIG. 18, in accordance with an embodiment, the system can receive from a customer data system an inventory and supplier data or information 220 for purposes of providing procurement assistance, for example providing an indication of suppliers A 222, B 224, and N 226 that can provide a particular item, such as a product or units thereof.

As illustrated in FIG. 19, in accordance with an embodiment, when it is determined by the system that an inventory position is less than a safety stock level, then the system can display an interface including a recommendation as to an order to be placed, including for example performing a simulation to find a lowest cost associated with the order, while achieving a target service level, and then directing the order to an appropriate supplier, in this example supplier B.

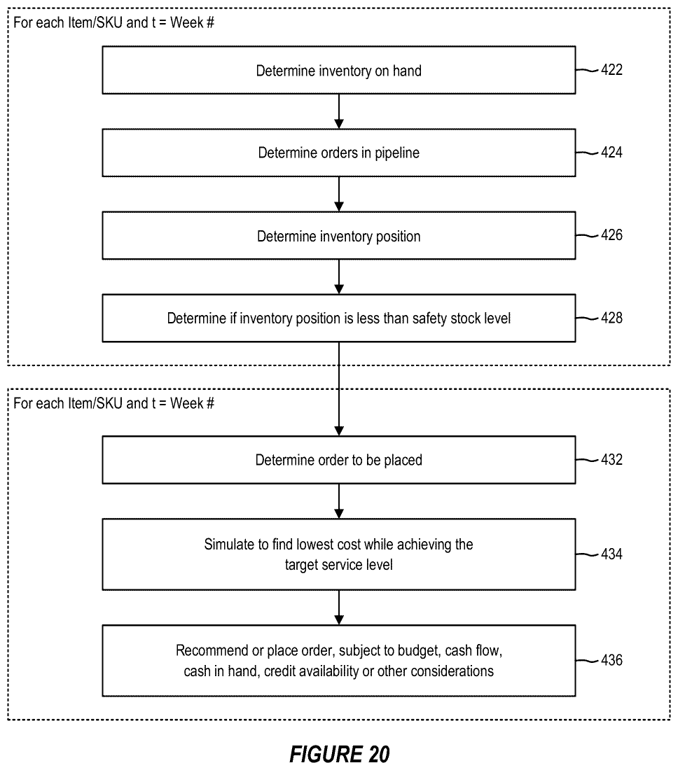

FIG. 20 illustrates a process or method for providing intelligent procurement assistance, in accordance with an embodiment.

As Illustrated in FIG. 20, in accordance with an embodiment, the process comprises, for each item (e.g., SKU) within an inventory, and a particular time period (t=week #) at step 422, determining the inventory on hand.

At step 424, the system determines orders currently in pipeline.

At step 426, the system determines a present inventory position.

At step 428, the system determines if the inventory position is less than a safety stock level. If a determination is made that the inventory position is less than the safety stock level, then the process continues to the next step; otherwise the process can pause until the next time period for assessment.

If the determination is made that the inventory position is less than the safety stock level, then, for each item (e.g., SKU) within the inventory, and particular time period (t=week #), the system, at step 432, determines an order to be placed.

At step 434, the system performs a simulation to find a lowest cost associated with the order, while achieving a target service level.

At step 436, the system can recommend or place an order, subject to budget, cash flow, cash in hand, credit availability or other considerations.

### Technical Advantages

In accordance with an embodiment, technical advantages of the systems and methods described herein can include, for example:

Simulation of future state: the described approach can assess a current state of the procurement system, including inventory, orders, shipments, usage etc. And determine what will be the next optimal state to reduce cost. This state-based approach to proceed from one state to another and finding the lowest cost state, while meeting the customer service level and our profit goals is the optimal state. The system can include all known variables that impact procurement by taking current state, past trends and time series predictions of the immediate future.

Procurement aggregation by item and vendor: net purchases of item-quantity by multiple departments, at various times, in different locations, with different orders, from different vendors vendor-item clusters-single item aggregated to one order. Multiple items from multiple vendors aggregated to one order.

Existing solutions assume quasi-static demand patterns, assume fixed lead times, assume that there are no stock-outs as if demands, usage and lead times are perfectly known when orders are placed, assuming that item costs are fixed with no changes in the market or via discounts. In the real world, these assumptions turn out to be false, as lead times keep fluctuating, there are stockouts, demand is highly dynamic, usage timelines depend on multiple factors, and item costs track the market changes. The system can take all these variabilities into account to forecast these inputs, and then optimize for the most economical order to vendors for items needed at the optimal location at the optimal time for the lowest cost.

In accordance with various embodiments, the systems and methods described herein can be implemented using one or more computer, computing device, machine, or microprocessor, including one or more processors, memory and/or computer readable storage media programmed according to the teachings of the present disclosure. Appropriate software coding can readily be prepared by skilled programmers based on the teachings of the present disclosure, as will be apparent to those skilled in the software art.

In some embodiments, the teachings herein can include a computer program product which is a non-transitory computer readable storage medium (media) having instructions stored thereon/in which can be used to program a computer to perform any of the processes of the present teachings. Examples of such storage mediums can include, but are not limited to, hard disk drives, hard disks, hard drives, fixed disks, ROMs, RAMs, EPROMs, EEPROMs, DRAMs, VRAMs, flash memory devices, or other types of storage media or devices suitable for non-transitory storage of instructions and/or data.

The foregoing description has been provided for the purposes of illustration and description. It is not intended to be exhaustive or to limit the scope of protection to the precise forms disclosed. Many modifications and variations will be apparent to the practitioner skilled in the art. For example, although several of the examples provided herein illustrate use with cloud environments such as Oracle Analytics Cloud; in accordance with various embodiments, the systems and methods described herein can be used with other types of enterprise software applications, cloud environments, cloud services, cloud computing, or other computing environments.

The embodiments were chosen and described in order to best explain the principles of the present teachings and their practical application, thereby enabling others skilled in the art to understand the various embodiments and with various modifications that are suited to the particular use contemplated. It is intended that the scope be defined by the following claims and their equivalents.

What is claimed is:

1. A system for providing procurement assistance, comprising:
a computer comprising one or more microprocessors, and a cloud or other computing environment operating thereon, wherein the system performs a method comprising, for each item within an inventory, and a particular time period:
determining the inventory on hand;
determining orders currently in pipeline; and
determining that an inventory position is less than a safety stock level and in response thereto, for each item within the inventory, and particular time period:
determining an order to be placed; and
performing a simulation to find a lowest cost associated with the order, while achieving a target service level.

2. The system of claim 1, wherein the system operates as a supply chain command center for intelligent procurement assistance, based on an assessment of inventory trends, demand, or other inputs related to the procurement or management of an inventory of items.

3. The system of claim 1, wherein the method comprises simultaneously optimizing for a set of variables related to procurement, by creating time series forecasts of leaf-level independent variables, and performing a simulation within the boundary conditions of historical or expected distributions of each variable, to determine an optimal timing, quantity, location and/or vendor for each order of items that are to be placed in the inventory.

4. The system of claim 1, wherein the method is performed by one or more components of a data analytics environment.

5. The system of claim 1, wherein the method comprises receiving an inventory and supplier data or information into the data analytics environment for purposes of providing procurement assistance, and displaying within a user interface one or more procurement recommendations.

6. A method providing procurement assistance, comprising:
providing a computer comprising one or more microprocessors, and a cloud or other computing environment operating thereon; and
for each item within an inventory, and a particular time period:
determining the inventory on hand;
determining orders currently in pipeline; and
determining that an inventory position is less than a safety stock level and in response thereto, for each item within the inventory, and particular time period:
determining an order to be placed; and
performing a simulation to find a lowest cost associated with the order, while achieving a target service level.

7. The method of claim 6, wherein the method operates as a supply chain command center for intelligent procurement assistance, based on an assessment of inventory trends, demand, or other inputs related to the procurement or management of an inventory of items.

8. The method of claim 6, wherein the method comprises simultaneously optimizing for a set of variables related to procurement, by creating time series forecasts of leaf-level independent variables, and performing a simulation within the boundary conditions of historical or expected distributions of each variable, to determine an optimal timing, quantity, location and/or vendor for each order of items that are to be placed in the inventory.

9. The method of claim 6, wherein the method is performed by one or more components of a data analytics environment.

10. The method of claim 6, wherein the method comprises receiving an inventory and supplier data or information into the data analytics environment for purposes of providing procurement assistance, and displaying within a user interface one or more procurement recommendations.

11. A non-transitory computer readable storage medium, including instructions stored thereon which when read and executed by one or more computers cause the one or more computers to perform a method comprising, for each item within an inventory, and a particular time period:
determining the inventory on hand;
determining orders currently in pipeline; and
determining that an inventory position is less than a safety stock level and in response thereto, for each item within the inventory, and particular time period:
determining an order to be placed; and
performing a simulation to find a lowest cost associated with the order, while achieving a target service level.

12. The non-transitory computer readable storage medium of claim 11, wherein the method operates as a supply chain command center for intelligent procurement assistance, based on an assessment of inventory trends, demand, or other inputs related to the procurement or management of an inventory of items.

13. The non-transitory computer readable storage medium of claim 11, wherein the method comprises simultaneously optimizing for a set of variables related to procurement, by creating time series forecasts of leaf-level independent variables, and performing a simulation within the boundary conditions of historical or expected distributions of each variable, to determine an optimal timing, quantity, location and/or vendor for each order of items that are to be placed in the inventory.

14. The non-transitory computer readable storage medium of claim 11, wherein the method is performed by one or more components of a data analytics environment.

15. The non-transitory computer readable storage medium of claim 11, wherein the method comprises receiving an inventory and supplier data or information into the data analytics environment for purposes of providing procurement assistance, and displaying within a user interface one or more procurement recommendations.
